(19) United States
(12) Patent Application Publication
(10) Pub. No.: US 2018/0328415 A1
(43) Pub. Date: Nov. 15, 2018

(54) Lamella for a Frictional Shift Element

(71) Applicant: ZF Friedrichshafen AG, Friedrichshafen (DE)

(72) Inventors: Derk Langenkaemper, Lindau (DE); Steffen Gerteiser, Eriskirch (DE); Stefan Schmidt, Friedrichshafen (DE)

(21) Appl. No.: 15/774,422

(22) PCT Filed: Jul. 22, 2016
(86) PCT No.: PCT/EP2016/067478

§ 371 Date: May 8, 2018

(30) Foreign Application Priority Data
Nov. 9, 2015 (DE) 10 2015 221 932.1

(51) Int. Cl. F16D 13/64; F16D 13/72

(52) U.S. Cl. CPC F16D 13/648; F16D 2065/1312; F16D 13/72

(57) ABSTRACT

A disk (1) for a friction-locking shift element includes an annular frictional surface with a circumferential first groove (31), a plurality of second grooves (32), and a plurality of third grooves (33). At least a section of each of the second grooves (32) at a respective radially internal deflection point (41) is oriented to form an angle (46a) with a line (45) between a center of rotation (44) of the disk (1) and the respective radially internal deflection point (41). The angle (46a) is no less than thirty-five degrees and no greater than seventy-five degrees.

### FIELD OF THE INVENTION

The invention relates generally to a disk for a friction-locking shift element. The invention further relates generally to a friction-locking shift element including such a disk, and to a transmission for a motor vehicle including such a friction-locking shift element.

### BACKGROUND

International application WO 2009/021569 A1 describes a frictional part for a device operating in a friction-locking manner, said part including an annular frictional surface which includes an inner edge and an outer edge, wherein provided in the frictional surface is a circumferential first groove, which extends between radially internal and radially external deflection points in a zig-zag or undulating manner, multiple second grooves, which originate from the inner edge and extend to the internal deflection points, and multiple third grooves which originate from the outer edge and extend essentially in the radial direction into the circumferential first groove and open, at opening points, into the circumferential first groove. The second grooves extend along a radial of the frictional part in this case.

In such a rotating frictional part as a component of a friction-locking shift element, i.e., a multi-disk clutch or a multi-disk brake, if cooling oil is supplied radially from the outside to the third grooves, the oil flows from the third grooves into the circumferential first groove. A preponderant portion of the oil is slung out again, via the third grooves, due to the centrifugal forces, without entering the second grooves. This results in a cooling effect which is unevenly distributed across the radius of the frictional surface, and therefore the radially outer area of the frictional surface is cooled substantially better than the radially inner area of the frictional surface. This is undesirable.

### SUMMARY OF THE INVENTION

Example aspects of the invention provide a groove pattern for a disk, which allows for an improved cooling of the radially inner area of the frictional surface when cooling oil is supplied radially from the outside.

According to the invention, the groove pattern known in the prior art is modified in such a way that the alignment of at least that section of the second grooves which opens at the radially internal deflection points, and a line between a center of rotation of the disk and the deflection point assigned to the particular second groove forms an angle between 35 degrees (35°) and 75 degrees (75°), preferably an angle between 45 degrees (45°) and 65 degrees (65°). In other words, as compared to the prior art, the second grooves now no longer extend in the radial direction, but rather obliquely thereto. When the disk rotates about its axis, a cooling fluid flowing through the circumferential first groove runs along the first groove. Due to the second grooves, which are now obliquely arranged, a flow distribution takes place at the internal deflection points, wherein a portion of the cooling fluid continues to flow along the circumferential first groove, and the remaining portion flows into the second groove. As a result, a cooling of the radial inner area of the frictional surface takes place which is improved as compared to the prior art.

Preferably, the second grooves are designed as straight lines. As a result, the flow loss of the cooling fluid through the second grooves is low, whereby the cooling effect of the radial inner area of the frictional surface is further improved.

Preferably, the second grooves originate from the radially internal deflection points and extend, in pairs, to the inner edge of the frictional surface. As a result, the improved cooling effect of the radial inner area of the frictional surface can be achieved independently of the direction of rotation of the disk.

In an embodiment of the second grooves in pairs, each groove of a groove pair preferably forms the same angle with respect to the line between the center of rotation of the disk and the deflection point assigned to the groove pair. As a result, a uniform cooling effect is achieved independently of the direction of rotation of the disk.

The third grooves extend essentially in the radial direction from the outer edge of the disk to the opening points into the circumferential first groove. The term “essentially” is understood to mean an alignment of the third grooves, which deviates from the radial direction of the disk by a maximum of 10 degrees (10°), preferably by a maximum of 5 degrees (5°). This deviation can take place in both directions, i.e., positive 10 degrees (10°) or negative 10 degrees (−10°). The deviation from the radial direction can relate to none, all, or only a portion of the third grooves. Such an essentially radial alignment of the third grooves facilitates a penetration by oil originating from the outer edge of the disk toward the circumferential first groove and, in fact, independently of the direction of rotation of the disk.

If the alignment of the third grooves deviates from the radial direction, the alignment deviation of third grooves which are adjacent to each other is preferably diametrically opposed. If the alignment deviation of a third groove is plus 5 degrees (5°), for example, the alignment deviation of a third groove directly adjacent to this third groove is minus 5 degrees (−5°). As a result, a symmetrical design of the groove pattern can be achieved, and therefore the installation direction does not need to be considered when mounting the disk.

Preferably, the disk is designed as a lined disk. A lined disk usually includes an annular steel body. Lining bodies are attached on the face ends of the steel body. The surface of the lining bodies facing away from the steel body forms the frictional surface of the disk. The grooves in the disk can be formed either by grooves in the lining bodies or by recesses between the lining bodies. The embodiment of the grooves according to the invention permits a limitation to only four different lining body shapes. Therefore, the disk can be manufactured without greater expenditure despite the more complex groove pattern as compared to the prior art.

Preferably, the opening points of the third grooves are arranged between the deflection points of the circumferential first groove. Alternatively thereto, the opening points can coincide with the radially outer deflection points of the first groove. According to yet another advantageous variant, the opening points of the third grooves can coincide with the radially inner deflection points of the first groove, i.e., can be congruent. As a result, the flow originating from the third grooves into the second grooves can be improved.

Preferably, the width of the circumferential first groove, the second grooves, and the third grooves is identical. According to one alternative embodiment, the width of the second grooves is greater than the width of the circumferential first groove. As a result, the flow resistance of the second grooves is reduced as compared to the flow resistance of the circumferential first groove, and therefore a penetration by the oil radially from the outside toward the inner edge of the disk is facilitated.

The disk according to the invention can be an integral part of a friction-locking shift element, for example of a multi-disk clutch or a multi-disk brake. In this case, multiple outer clutch disks and multiple inner clutch disks are successively arranged so as to alternate in the axial direction. The outer clutch disks are connected to an outer disk carrier in a rotationally fixed and axially displaceable manner. The inner clutch disks are connected to an inner disk carrier in a rotationally fixed and axially displaceable manner. The disks according to the invention form either the inner clutch disks or the outer clutch disks. The friction-locking shift element includes a device in this case, which is designed for feeding fluid radially from the outside toward the outer edge of the disk according to the invention. The friction-locking shift element designed in such a way can be an integral part of a transmission for a motor vehicle. In this case, the friction-locking shift element operates as a starting component in the drive train of a motor vehicle. Such a starting component allows for a slip state between the drive source and the driving wheels of the motor vehicle during the starting process. In this case, particularly in the case of a starting process under high load, for example on an uphill grade and with a loaded motor vehicle trailer, a high input of energy into the starting component can occur. Due to the improved cooling effect, which is more uniform across the radius of the frictional surface, the friction-locking shift element is particularly suitable for the application as a starting component.

### BRIEF DESCRIPTION OF THE DRAWINGS

Exemplary embodiments of the invention are described in detail in the following with reference to the attached figures. Wherein:

FIG. 1 shows a face-end view of a disk according to the invention;

FIG. 2 shows an enlarged section of the face-end view;

FIG. 3 shows a section of an isometric view of the disk according to the invention;

FIG. 4 shows a face-end view of a second embodiment of the disk according to the invention;

FIG. 5 shows an enlarged section of the face-end view from FIG. 4;

FIGS. 6 to 9 show face-end views of groove patterns of alternative embodiments of the disk according to the invention;

FIG. 10 shows a cutaway view of a friction-locking shift element; and

FIG. 11 shows a schematic representation of a transmission for a motor vehicle.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

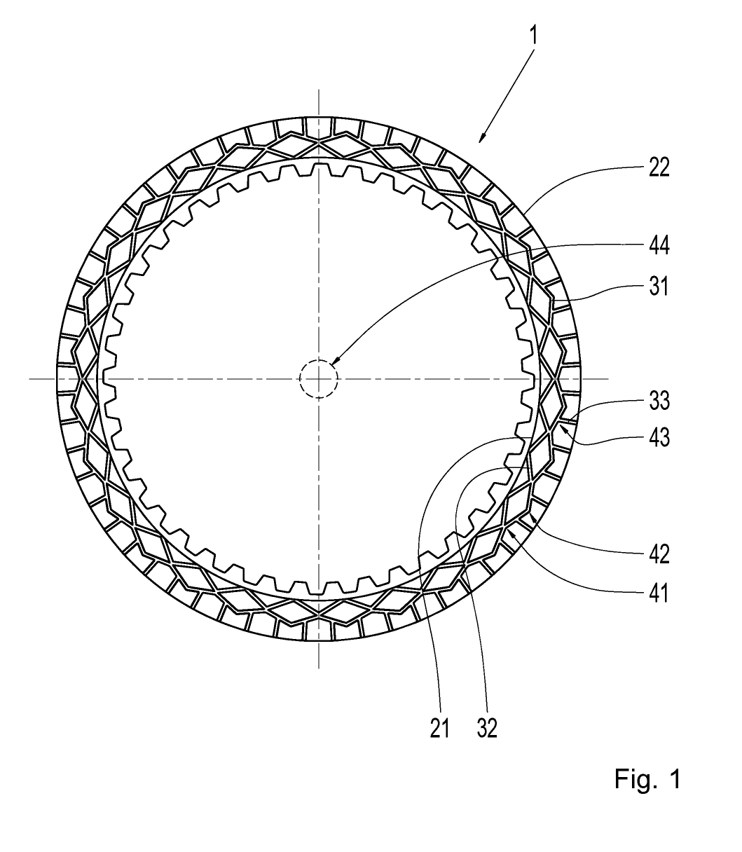

FIG. 1 shows a face-end view of a disk 1, arranged around a center of rotation 44 of the disk 1. The disk 1 includes an annular frictional surface which includes an inner edge 21 and an outer edge 22. Provided in the frictional surface is a symmetrical groove pattern consisting of a circumferential first groove 31, multiple second grooves 32, and multiple third grooves 33. The first groove 31 extends, in a zig-zag or undulating manner, between radially internal deflection points 41 and radially external deflection points 42 in the circumferential direction of the disk 1. The second grooves 32 extend, in pairs, originating from the inner edge 21 to the radially internal deflection points 41. The third grooves 33 originate from the outer edge 22 and extend into the circumferential first groove 31, and are aligned in the radial direction. Opening points 43 of the third grooves 33 into the circumferential first groove 31 are located between the deflection points 41, 42.

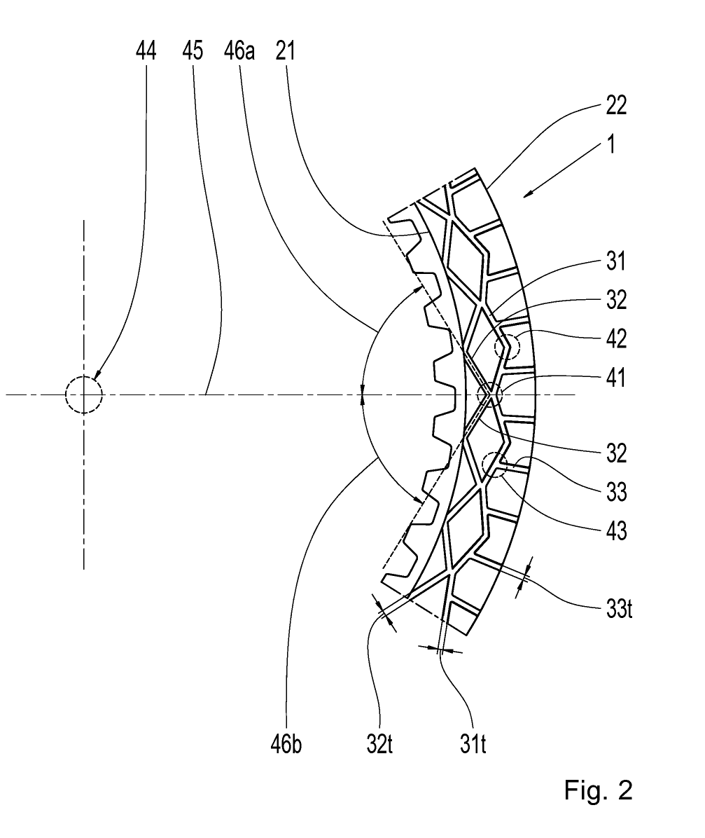

FIG. 2 shows an enlarged section of the face-end view depicted in FIG. 1. The second grooves 32 are designed essentially as straight lines. The angle 46a, 46b of each of the second grooves 32 with respect to a line 45 which extends between the center of rotation 44 and the deflection point 41 assigned to the groove 32 is between 35 degrees (35°) and 75 degrees (75°), and is approximately 55 degrees (55°) in the exemplary embodiment represented. The width 31t of the first groove 31, the width 32t of the second grooves 32, and the width 33t of the third grooves 33 are identical.

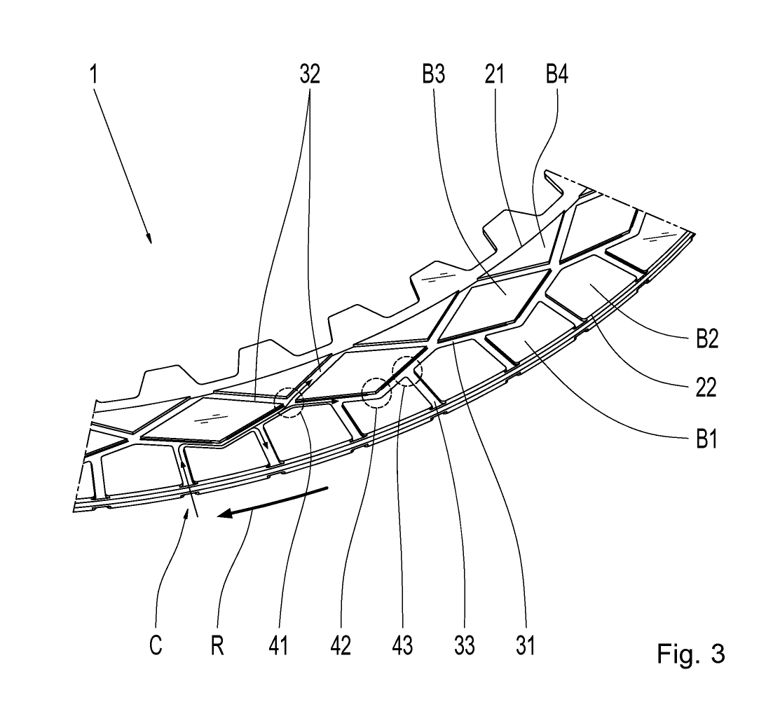

FIG. 3 shows a section of an isometric view of the disk 1, on the basis of which the mode of operation according to the invention is clearly apparent. A cooling oil flow C originates from the outer edge 22 and enters the third grooves 33. In the case of a given direction of rotation R of the disk 1, the cooling oil flow C flows, relative to the disk 1, through the circumferential first groove 31 counter to the direction of rotation R. Due to the centrifugal force, a portion of the cooling oil flow C re-emerges from the third groove 33 which follows in the circumferential direction, while the remaining portion of the cooling flow C continues to flow through the circumferential first groove 31. The cooling oil flow C now impacts one of the internal deflection points 41. Due to the alignment of the second grooves 32 according to the invention, a division of the cooling oil flow C takes place between the first groove 31 and the second groove 32 which originates from the deflection point 41 and is aligned counter to the direction of rotation R. If the direction of rotation R of the disk 1 is always the same, then one single groove 32 suffices, which originates from each deflection point 32 and extends to the inner edge 21, wherein these grooves 32 are to be aligned counter to the direction of rotation R. If the improved cooling function of the disk 1 is to take place independently of the direction of rotation R, the design of the second grooves 32 in pairs is to be preferred, as represented in the exemplary embodiment.

It is also clearly apparent in FIG. 3 that the disk 1 is a lined disk. The grooves 31, 32, 33 are formed by recesses between the lining bodies. The disk 1 includes precisely four different lining body shapes B1, B2, B3, B4 in this case.

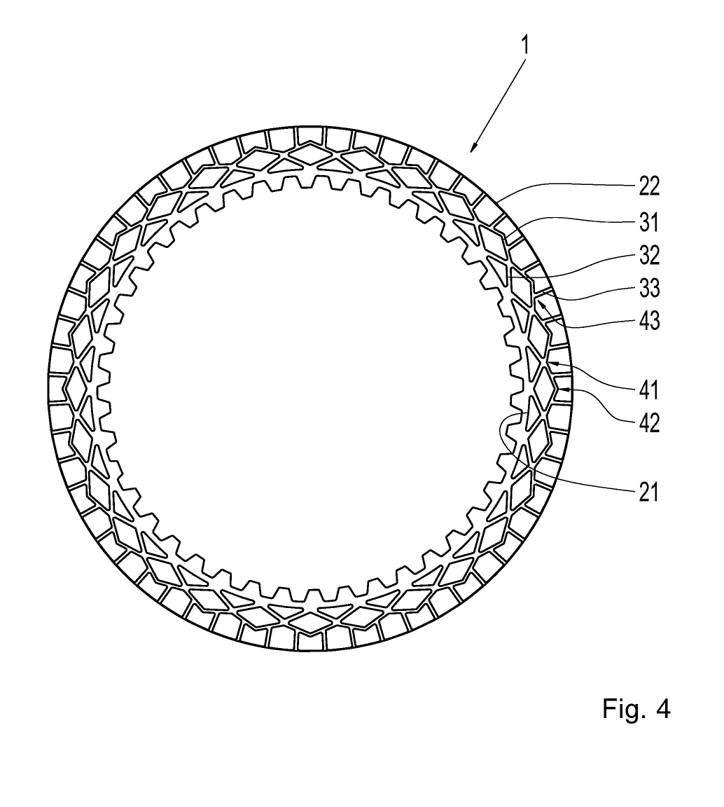

FIG. 4 shows a face-end view of a second embodiment of the disk 1 according to the invention, which essentially corresponds to the embodiment represented in FIG. 1. The rhomboid lining bodies have been arranged radially farther outward in this case, whereby the third grooves 33 now have a larger width than the circumferential first groove.

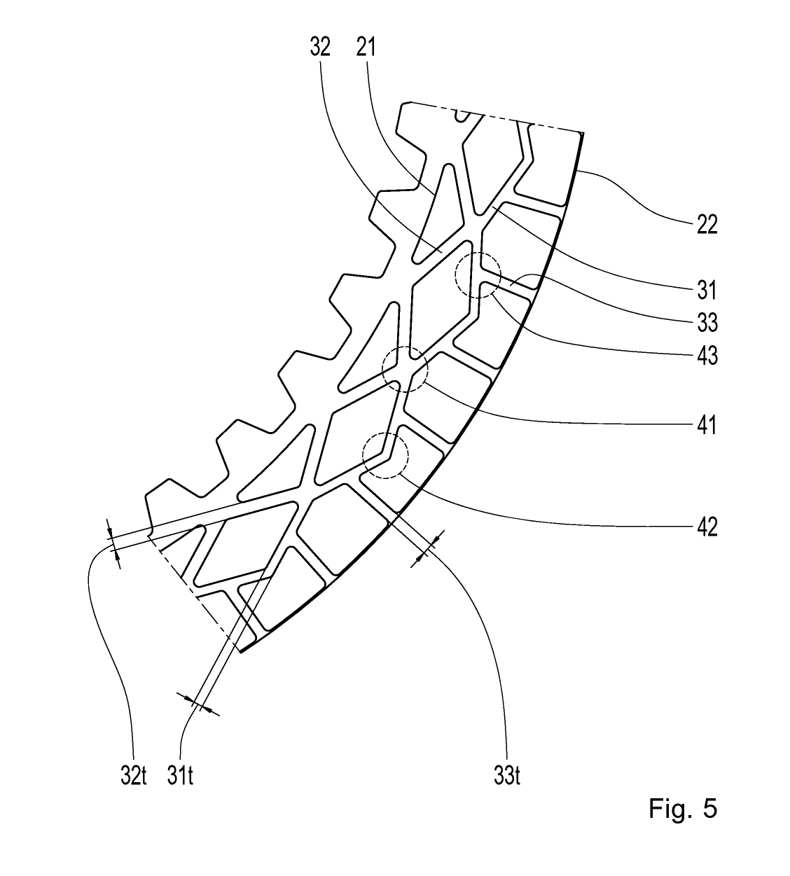

FIG. 5 shows a detailed view of the disk 1 according to the second embodiment. Therein, the enlarged width 32t of the second grooves 32 as compared to the now smaller width 31t of the circumferential first groove 31 is clearly apparent. The width 33t of the third grooves 33 is unchanged.

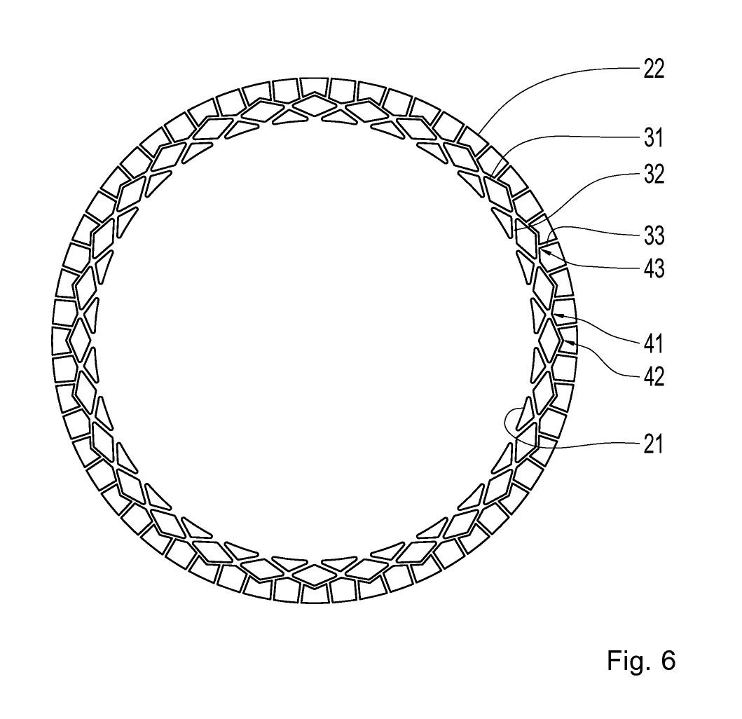

FIG. 6 shows a groove pattern of a disk 1 according to the invention, which essentially corresponds to the second embodiment represented in FIG. 4. Only the alignment of the third grooves 33 has been changed, so that the third grooves now deviate from the radial direction of the disk 1 by 5 degrees (5°). The deviation of third grooves 33 which are adjacent to each other is diametrically opposed in this case, and therefore a symmetrical groove pattern results.

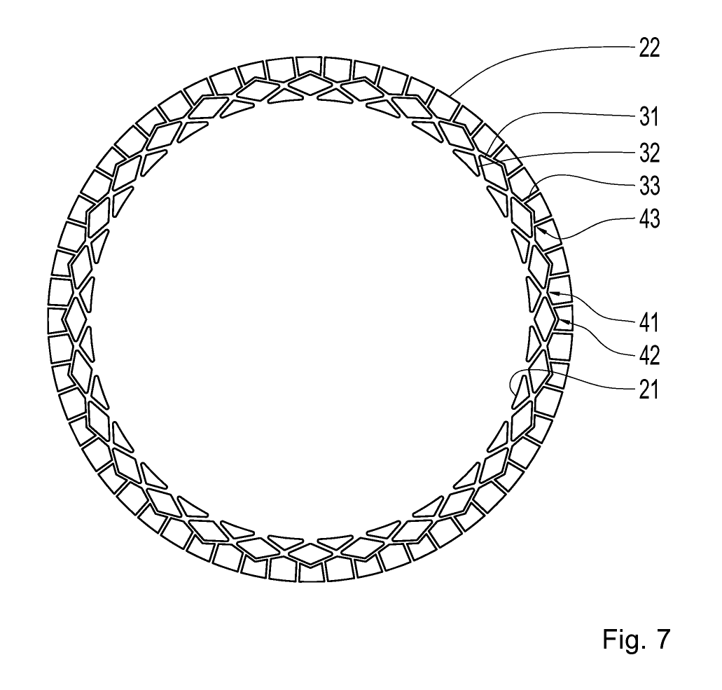

FIG. 7 also shows a groove pattern of a disk 1 according to the invention, in which an alignment of the third grooves 33 deviates from the radial direction of the disk 1. The deviation of third grooves 33 which are adjacent to each other is diametrically opposed once more, and therefore a symmetrical groove pattern results. As compared to the groove pattern represented in FIG. 6, the angular alignment has been changed, so that the lining bodies assigned to the internal deflection points 41 are wider than in the embodiment according to FIG. 6.

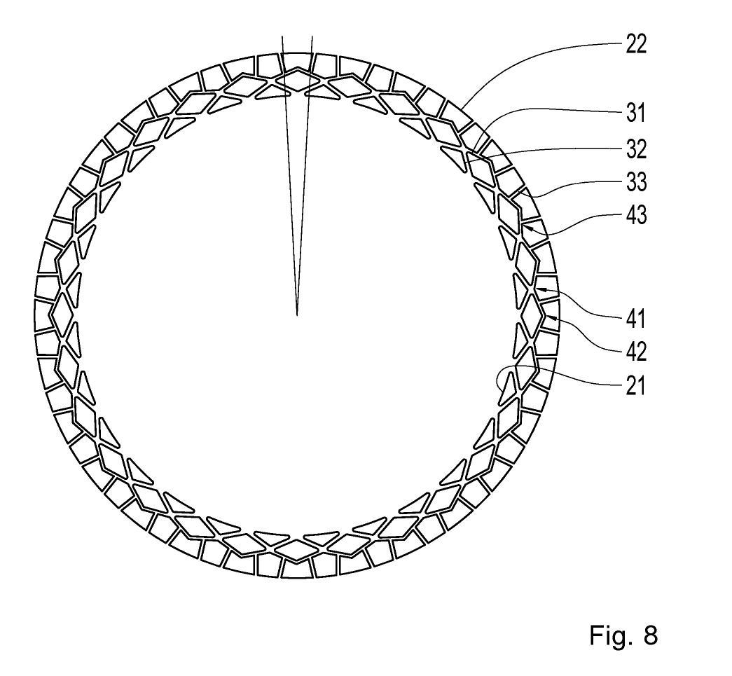

FIG. 8 shows a groove pattern of a disk 1 according to the invention, in which an alignment of the third grooves 33 deviates from the radial direction of the disk 1. The angular alignment corresponds to the groove pattern according to FIG. 6, although having an angle of 10 degrees (10°) originating from the radial direction of the disk 1.

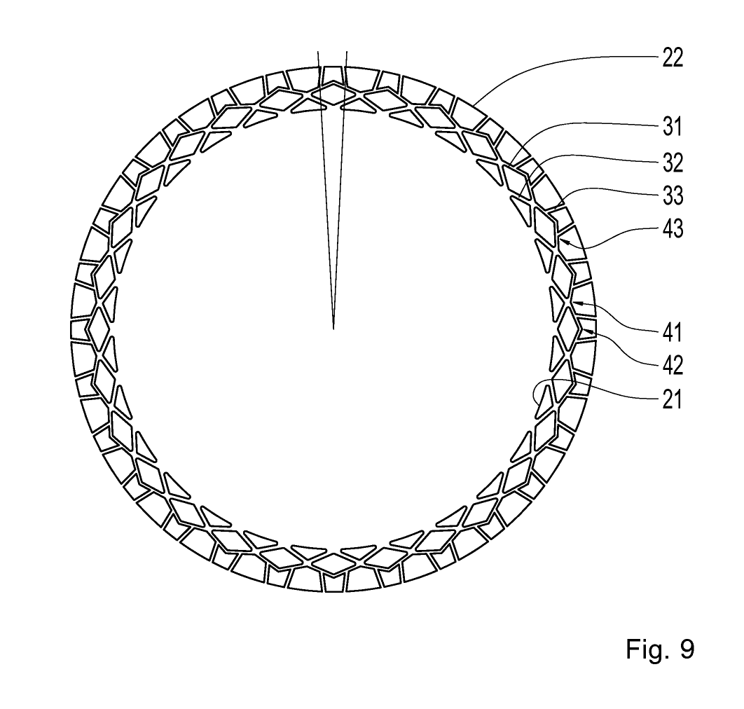

FIG. 9 also shows a groove pattern of a disk 1 according to the invention, in which an alignment of the third grooves 33 deviates from the radial direction of the disk 1. The angular alignment corresponds to the groove pattern according to FIG. 7, although having an angle of 10 degrees (10°) originating from the radial direction of the disk 1.

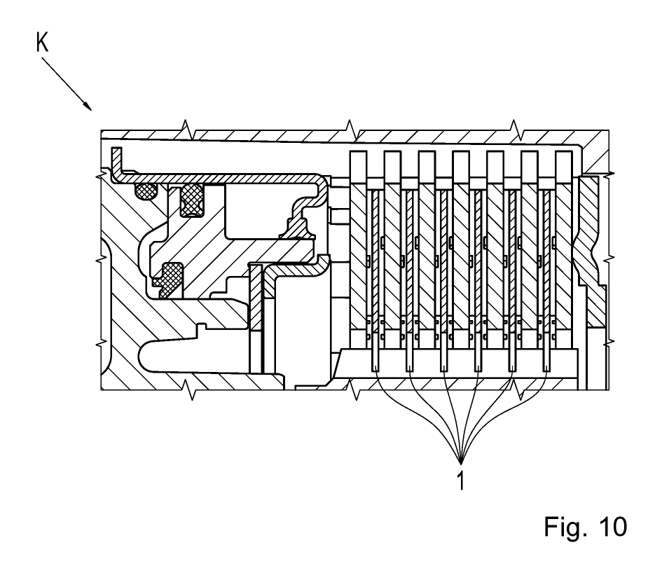

FIG. 10 shows a cutaway view of a friction-locking shift element K, in which the disks 1 according to the invention are designed as inner clutch disks. The friction-locking shift element K operates as a brake, by way of example. The inner clutch disks are arranged axially in succession and in alternation with outer clutch disks. The outer clutch disks are designed as steel disks. The friction-locking shift element K includes a device for feeding fluid, for example cooling oil. The fluid is supplied radially from the outside to the disk pack. As a result, fluid can be supplied radially from the outside to the inner clutch disks 1.

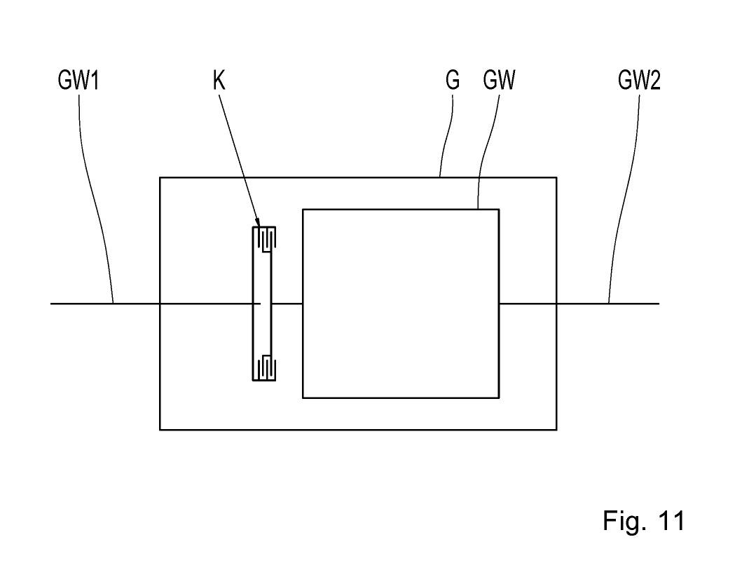

FIG. 11 shows a schematic representation of a transmission G for a motor vehicle. The transmission G includes an input shaft GW1, an output shaft GW2, and a gearshift section GW. The input shaft GW1 acts as an interface to a transmission-external drive unit, for example an internal combustion engine of the vehicle. The output shaft GW2 acts as an interface to an axle transmission of the vehicle, via which the power present at the output shaft GW2 is distributed to driving wheels of the vehicle. The gearshift section GW is configured for forming various transmission ratios between the input shaft GW1 and the output shaft GW2. The friction-locking shift element K is arranged between the input shaft GW1 and the gearshift section GW. By the friction-locking shift element K, a slip state between the input shaft GW1 and the output shaft GW2 can be formed, for example during a starting process of the motor vehicle. The friction-locking shift element K can also be an integral part of the gearshift section GW.

Modifications and variations can be made to the embodiments illustrated or described herein without departing from the scope and spirit of the invention as set forth in the appended claims.

### REFERENCE CHARACTERS

1 disk
21 inner edge
22 outer edge
31 first groove
31t width of the first groove
32 second grooves
32t width of the second grooves
33 third grooves
33t width of the third grooves
41 radially internal deflection points
42 radially external deflection points
43 opening points
44 center of rotation
45 line
46a/b angle
R direction of rotation
C cooling oil flow
B1 lining body shape
B2 lining body shape
B3 lining body shape
B4 lining body shape
K friction-locking shift element
G transmission
GW1 input shaft
GW2 output shaft
GW gearshift section

1-14: (canceled)

15. A disk (1) for a friction-locking shift element, comprising:
an annular frictional surface including an inner edge (21) and an outer edge (22), the annular frictional surface provided with a circumferential first groove (31), a plurality of second grooves (32), and a plurality of third grooves (33),
wherein the first groove (31) zig-zags or undulates between radially internal deflection points (41) and radially external deflection points (42),
wherein each of the second grooves (32) originates from the inner edge (21) and extends to a corresponding one of the radially internal deflection points (41),
wherein each of the third grooves (33) originates from the outer edge (22) and extends into the circumferential first groove (31) such that each of the third grooves (33) opens into the circumferential first groove (31) at a respective opening point (43), each of the third grooves (33) aligned essentially along a radial direction, and
wherein at least a section of each of the second grooves (32) at the respective radially internal deflection point (41) is oriented to form an angle (46a) with a line (45) between a center of rotation (44) of the disk (1) and the respective radially internal deflection point (41), the angle (46a) being no less than thirty-five degrees and no greater than seventy-five degrees.

16. The disk (1) of claim 15, wherein the angle (46a) is no less than forty-five degrees and no greater than sixty-five degrees

17. The disk (1) of claim 15, wherein the second grooves (32) are straight grooves.

18. The disk (1) of claim 15, wherein a pair of second grooves (32) originate from each of the radially internal deflection points (41) and extend toward the inner edge (21).

19. The disk (1) of claim 18, wherein at least a section of each of the pair of second grooves (32) at the corresponding one of the radially internal deflection points (41) forms a common angle (46a, 46b) with respect to the line (45).

20. The disk (1) of claim 15, wherein each of the third grooves (33) is oriented such that the third grooves (33) deviate by no more than ten degrees from the radial direction.

21. The disk (1) of claim 20, wherein each of the third grooves (33) is oriented such that a deviation of each of the third grooves (33) from the radial direction is diametrically opposite the deviation of adjacent third grooves (33).

22. The disk (1) of claim 15, wherein the disk (1) is a lined disk, and the lined disk comprises precisely four different lining body shapes (B1, B2, B3, B4) to form the annular frictional surface.

23. The disk (1) of claim 15, wherein the opening point (43) of each of the third grooves (33) is positioned between a respective one of the radially internal deflection points (41) and a respective one of the radially external deflection points (42) of the first groove (31).

24. The disk (1) of claim 15, wherein the opening points (43) of the third grooves (33) are congruent with the radially internal deflection points (41) of the first groove (31).

25. The disk (1) of claim 15, wherein a width of the first groove (31) is equal to a width of the second grooves (32) and a width of the third grooves (33).

26. The disk (1) of claim 15, wherein a width of the second grooves (32) is greater than a width of the first groove (31).

27. A friction-locking shift element (K) comprising a plurality of disks (1) of claim 15, and a device for feeding fluid to the outer edges (22) of the disks (1).

28. A transmission (G) for a motor vehicle comprising the friction-locking shift element (K) of claim 27, wherein the friction-locking shift element (K) is operable as a starting component of the motor vehicle.
